(19) United States
(12) Patent Application Publication
(10) Pub. No.: US 2015/0379540 A1
(43) Pub. Date: Dec. 31, 2015

(54) RESOURCE PACKAGE COMBINATION TO INDUCE DATACENTER PRICING STABILITY

(71) Applicant: Empire Technology Development LLC, Wilmington, DE (US)

(72) Inventor: Ezekiel Kruglick, Poway, CA (US)

(21) Appl. No.: 14/413,418

(22) PCT Filed: May 1, 2014
(86) PCT No.: PCT/US14/36365

§ 371 Date: Jan. 8, 2015

(51) Int. Cl. G06Q 30/02

(52) U.S. Cl. CPC G06Q 30/0206

(57) ABSTRACT

Technologies are generally provided to induce datacenter pricing stability. In some examples, a stabilizer module at a datacenter may be configured to monitor a customer demand for resources from the datacenter and real-time pricing for the demanded resources. The stabilizer module may detect an impending pricing instability in response to increased demand for resources, and may determine an incremental cost to provide the resources based on a determined linearity for available resources. The stabilizer module may determine combinations of linear and non-linear resources to offer to the customers based on a stability metric computed from the incremental cost and the resource demand, where the combination of resources to offer may have a more linear increase in cost per resource compared to one of the demanded resources.

### BACKGROUND

Unless otherwise indicated herein, the materials described in this section are not prior art to the claims in this application and are not admitted to be prior art by inclusion in this section.

Datacenters may host multiple virtual machines and servers to provide cloud-related data/computing services such as various applications, data storage, data processing, or comparable ones to a group of customers, such as individual users or enterprise customers, via a cloud. As customers demand more resources from the datacenter, new servers and/or new virtual machines may be initiated to add tasks to the datacenter in order to meet the demand for the resources. The costs of adding new tasks at the datacenter may be passed onto the customers in real-time demand and auction based pricing scenarios. Costs to provide the resources at the datacenter may have linear and superlinear relationships to increasing power supply needs, including increased voltage and frequency and cooling requirements. A result of superlinear incremental cost increases may be a positive feedback scenario, in which as customers see prices dramatically increasing, the customers may demand additional resources from the datacenter in attempt to meet their needs before prices increase further, which further drives up the operational costs of the datacenter. The increased demand and increased prices may lead to instability of the datacenter.

### SUMMARY

The present disclosure generally describes techniques to provide a resource package to induce datacenter pricing stability.

According to some examples, the present disclosure describes methods to induce datacenter pricing stability. Example methods may include determining a demand for one or more resources of the datacenter based on past usage received at a datacenter, determining an incremental cost to provide the one or more demanded resources, and determining a combination of two or more resources to offer, where the combination of resources to offer has a more linear increase in cost per resource compared to one of the demanded resources. Determining the demand for the one or more resources of the datacenter based on past usage may include determining the demand based on winning and non-winning bids received at the datacenter.

According to other examples, systems to induce datacenter pricing stability are also described. Example systems may include a datacenter resource management system, and a stabilizer module communicatively coupled to the datacenter resource management system, where the stabilizer module may be configured to determine a demand for one or more resources of the datacenter based on winning and non-winning bids received at the datacenter, compute an incremental cost to provide the one or more resources based on a resource type and a current resource supply cost, and determine a combination of two or more resources to offer based on the incremental cost, where the combination of resources to offer has a more linear increase in cost per resource compared to one of the demanded resources.

According to some examples, devices to induce datacenter pricing stability are also described. Example devices may include a memory configured to store instructions and a processor configured to execute a stabilizer module in conjunction with the instructions. The stabilizer module may be configured to determine a demand for one or more resources of a datacenter based on winning and non-winning bids received at the datacenter, compute an incremental cost to provide the one or more resources based on a resource type and a current resource supply cost, and determine a combination of two or more resources to offer based on a stability metric computed from the incremental cost and the determined demand, where the combination of resources to offer has a more linear increase in cost per resource compared to one of the demanded resources.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example datacenter-based system where resource packages to induce datacenter pricing stability may be implemented;

FIG. 2 illustrates a diagram of an example datacenter feedback loop root locus plot with stable and unstable regions;

FIG. 3 illustrates a conceptual diagram of providing datacenter resources to one or more customers over a network;

FIG. 4 illustrates a conceptual diagram of a system to induce pricing stability at a datacenter employing a stabilization module;

FIG. 5 illustrates a general purpose computing device, which may be used to control a system for providing a stabilizing resource package to prevent datacenter pricing instability;

FIG. 6 is a flow diagram illustrating an example method that may be performed by a computing device such as the computing device in FIG. 5; and

FIG. 7 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to providing resource packages to induce datacenter pricing stability.

Briefly stated, technologies are generally provided to induce datacenter pricing stability. In some examples, a stabilizer module at a datacenter may be configured to monitor a customer demand for resources from the datacenter and real-time pricing for the demanded resources. The stabilizer module may detect an impending pricing instability in response to increased demand for resources, and may determine an incremental cost to provide the resources based on a determined linearity for available resources. The stabilizer module may determine combinations of linear and non-linear resources to offer to the customers based on a stability metric computed from the incremental cost and the resource demand, where the combination of resources to offer may have a more linear increase in cost per resource compared to one of the demanded resources.

A datacenter as used herein refers to an entity that hosts services and applications for customers through one or more physical server installations and one or more virtual machines executed in those server installations. Customers of the datacenter, also referred to as tenants, may be organizations that provide access to their services for multiple users. One example configuration may include an online retail service that provides retail sale services to consumers (users). The retail service may employ multiple applications (e.g., presentation of retail goods, purchase management, shipping management, inventory management, etc.), which may be hosted by one or more datacenters. Thus, a consumer may communicate with those applications of the retail service through a client application such as a browser over one or more networks and receive the provided service without realizing where the individual applications are actually executed. This scenario contrasts with configurations where each service provider would execute their applications and have their users access those applications on the retail service's own servers physically located on retail service premises. A result of the networked approach described herein is that resources such as applications and virtual machines on a datacenter may experience increased demand by clients, and may experience pricing instability as the resource demand and power needed to meet the demand increases.

Pricing stability as used herein refers to combination of datacenter resources to be offered to a datacenter client, where the combination may have a more linear increase in cost per resource compared to one of the demanded resources. Linear increase may include linear or sublinear increases.

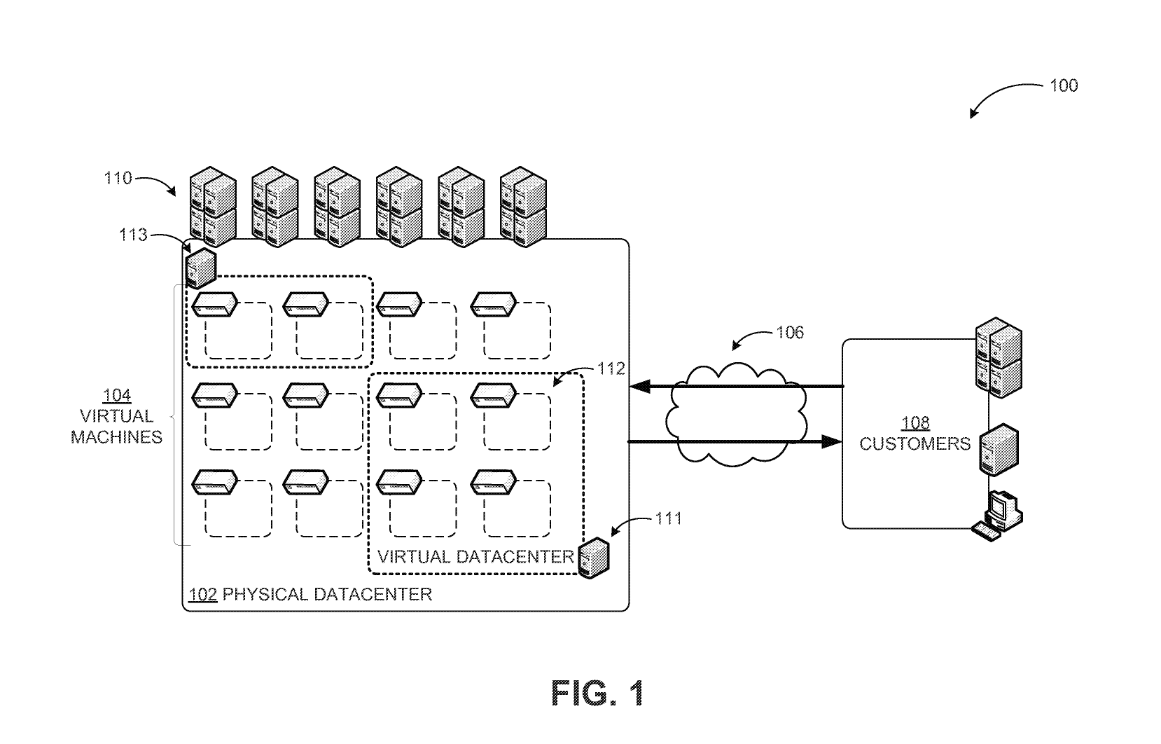

FIG. 1 illustrates an example datacenter-based system where resource packages to induce datacenter pricing stability may be implemented, arranged in accordance with at least some embodiments described herein.

As shown in a diagram 100, a datacenter 102 may include one or more physical servers 110, 111, and 113, each of which may be configured to provide one or more virtual machines 104. For example, the physical servers 111 and 113 may be configured to provide four virtual machines and two virtual machines, respectively. In some embodiments, one or more virtual machines may be combined into one or more virtual datacenters. For example, the four virtual machines provided by the physical servers 111 may be combined into a virtual datacenter 112. The virtual machines 104 and/or the virtual datacenter 112 may be configured to host a multitude of servers to provide cloud-related data/computing services such as various applications, data storage, data processing, or comparable ones to one or more customers 108, such as individual users or enterprise customers, via a cloud 106.

In an example embodiment, as the customers 108 demand more resources from the datacenter 102, new servers and/or new virtual machines may be initiated to add tasks to the datacenter in order to meet the demand for the resources. The costs of adding new tasks at the datacenter 102 may be passed onto the customers 108 in real-time demand and auction based pricing scenarios. Costs to operate the virtual machines 104 at the datacenter 102 to meet the customer demand may have linear and superlinear (i.e., quadratic and cubic) relationships to cost because of factors such as increasing power supply requirements, including increased voltage and frequency and frequency requirements. For example, initiating a new virtual machine on a new processor may have a linear incremental cost, and adding a new virtual machine on an existing processor to the datacenter 102 may have a superlinear incremental cost. Superlinear costs may be attributed to a cost of increased voltages and frequencies needed to turn on a new virtual machine. Increasing the voltage and frequency may also increase the power per computation needed for existing tasks already operating on existing virtual machines on the processor. Each additional added task may need to pay for the power necessary for its own operation in addition to the power necessary for existing tasks to continue operating as voltage and power increase. Accordingly, each added task may have an incremental superlinear cost that is passed on to the customers 108. Specifically, the incremental cost may be quadratic for power expenditure involved. Additionally, the superlinear cost may become cubic when additional factors are considered. For example, a cooling input may be used to cool the datacenter 102 as the computational voltage and power increases, and the incremental superlinear cost may become cubic due to the contribution of the cooling input factor.

In an example embodiment, the customers 108 may be charged in dynamic real-time for datacenter usage, such as auction-based pricing and demand-based pricing. A result of the superlinear incremental cost increases may be a positive feedback scenario, in which as the customers 108 see prices increasing, the customers may expect higher prices, and may seek to meet their capacity needs before prices go even higher, resulting in even more power needed by the datacenter 102 to meet the increased demand. The customers 108 may demand additional resources from the datacenter 102 in attempt to meet their needs before prices increase further, which further drives up the costs of the datacenter 102. The increased demand and increased prices may lead to instability of the datacenter 102.

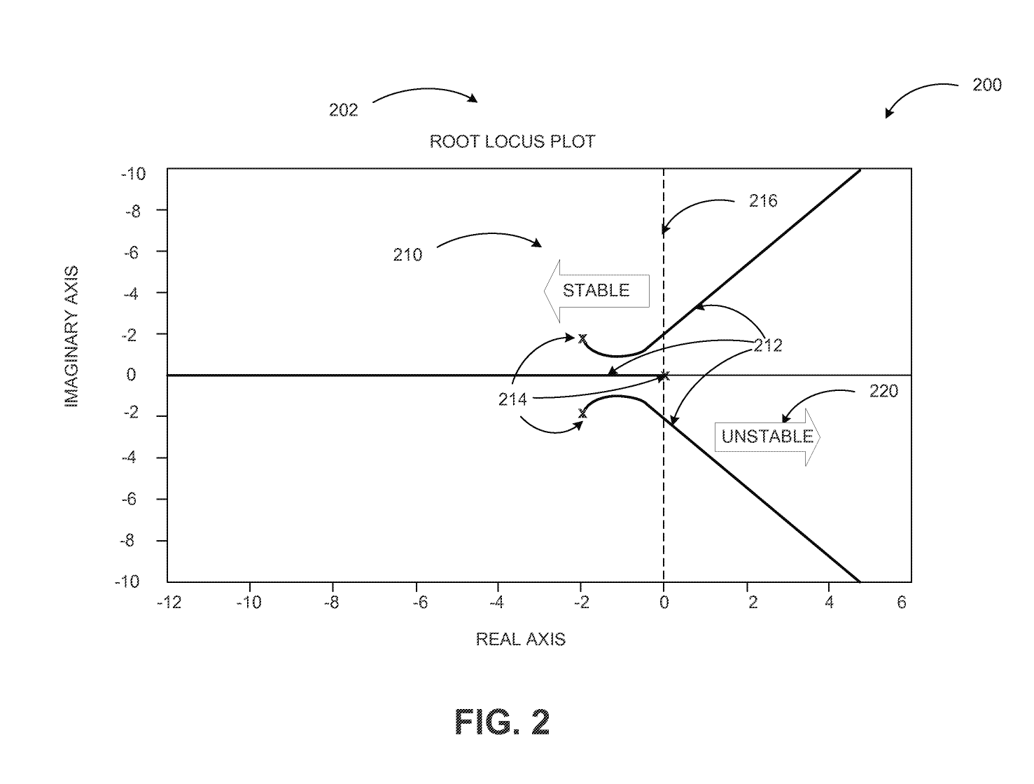

FIG. 2 illustrates a diagram of an example datacenter feedback loop root locus plot with stable and unstable regions, arranged in accordance with at least some embodiments described herein.

As shown in a diagram 200, a Root-Locus plot 202 may provide a graphical representation of the stability of a datacenter pricing system demonstrating stable and unstable regions in response to pricing mechanisms at a datacenter. The Root-Locus plot 202 may demonstrate a position of poles and zeros of a third order transfer function as a positive feedback loop gain increases. Poles 214 (e.g., marked as an “x” in the diagram 200) are a bottom of the transfer function that send an output of the transfer function to infinity. As the positive feedback loop gain increases, the poles 214 may move along a path illustrated by paths 212 of the Root-Locus plot 202. When the poles 214 are in a left hand plane (i.e., left of a zero-line 216) of the Root-Locus plot 202, the datacenter pricing may be stable 210, and when the poles 214 are in a right hand plane (i.e., right of the zero-line 216) of the Root-Locus plot 202, the datacenter pricing may be unstable 220.

In an example embodiment, a datacenter pricing system may be visualized by the Root-Locus plot 202. The datacenter pricing system may cause a positive feedback loop gain to increase as resource units sold increase, because an incremental cost (i.e., a slope of absolute cost) increases with units sold. With superlinear incremental costs for resources, the datacenter may experience instability as resource demand volumes increase. A feature observed in datacenters is that an incremental price offered for a resource needs to be at least as much as an incremental cost of offering the resources, and accordingly, the incremental cost of a unit of computation may be estimated as a derivative of the cost. For example, in a datacenter with a quadratic (x²) cost basis operating at any particular number of delivered units, x, prices on an offer may be reactive to a local slope (2x), which may be the derivative of the cost basis, or the absolute cost. A feedback loop in this scenario may effectively see a positive feedback loop gain that rises with each unit volume sold, which may be analogous to an increasing positive feedback loop gain of a rising feedback constant “k” in the Root-Locus plot 202. Comparison of the datacenter pricing feedback loop to the Root-Locus plot demonstrates that the datacenter pricing system may become unstable as units delivered is increased, similar to a system becoming unstable under increasing positive feedback loop gain in the Root-Locus plot 202 as demonstrated in the diagram 200.

A control-theory solution to the unstable 220 issue demonstrated in the Root-Locus plot 202 may be to add poles or zeros to change the path to keep the poles in the left hand plane of the Root-Locus plot 202. Such a solution may not be available in datacenter pricing systems since the positive feedback loop exists due to customer behavior in response to real-time pricing and resource demand. A system according to embodiments may provide a solution based on recognition that datacenter pricing may have linear and superlinear relationships to increasing power supply requirements in certain implementations. For example, turning on each incremental processor may add linear amounts of power usage and heat in order to supply services, while adding a virtual machine to an already running processor may add cost along a slope of degree 2 or 3 (i.e., x² or x³), which is the region where instability occurs. The instability may be due to that fact that increasing computing involves increasing frequency and voltage together, adding increasing incremental amounts of power per virtual machine at the datacenter. A system according to embodiments may detect an impending datacenter pricing instability, and may provide a combination of linear and superlinear resources to avoid the instability while minimizing a cost of providing the resources.

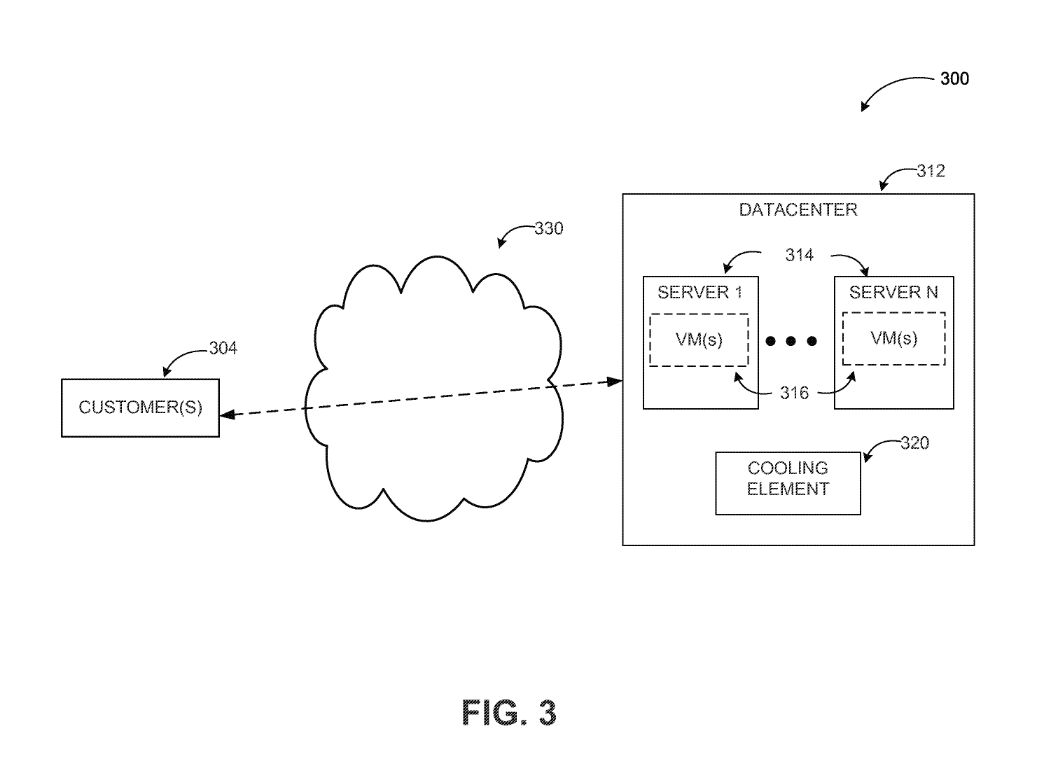

FIG. 3 illustrates a conceptual diagram of providing datacenter resources to one or more customers over a network, arranged in accordance with at least some embodiments described herein.

As shown in a diagram 300, one or more customers 304 may receive services from a datacenter 312 over a network, such as a cloud 330. The services provided to the customers 304 may include applications executed on servers 314. The applications executed for the customers 314 may be standalone applications or applications executed within virtual machines. Virtual machines (VMs 316) are software constructs provided by physical servers. A datacenter such as the datacenter 312 may include a number of physical servers. Each of the servers may include one or more processor, and each processor may execute multiple virtual machines. For example, a processor may execute 5 virtual machines, and a server may include 4 processors (quad-processor server). Thus, the example server may provide 20 virtual machines to the customers 304. In an example scenario, the virtual machines may act as desktop computers for the customers providing the functionality of a desktop computer along with typical applications that may be executed on the computer without the customer having to install all the applications on their local machine. Such a configuration may consume a variety of datacenter resources including, but not limited to, communication bandwidth, processor capacity, memory capacity, and persistent data storage. As customer needs change (for example, as the customers request additional applications to be executed, additional virtual machines to be provided, or increased/more complex computations to be performed), the datacenter 312 may use additional resources.

One example of providing additional services to the customers 304 is additional virtual machines. Because a limited number of virtual machines can be executed on each server, as the need for virtual machines grows, the datacenter 312 may bring one or more new servers online. Adding a new virtual machine on a new server may have a linear incremental cost, and adding a new virtual machine to a running server with other VMs already being executed may have a superlinear incremental cost. Superlinear costs may be attributed to a cost of increased power consumption per computation needed to increase processing to handle a new virtual machine on the already online server. Additionally, the datacenter 312 may use an active cooling element 320 to mitigate increased heat output of servers contributing to incremental costs of providing a resource. As discussed above, the superlinear incremental costs may lead to pricing instability in response to a positive feedback loop experienced as the customers 304 demand more resources from the datacenter 312 in response to increased prices.

A datacenter according to some embodiments may detect an impending pricing instability in response to increased demand for resources such as new virtual machines, and may determine an incremental cost to provide the resources based on a determined linearity for available resources. Next, combinations of linear and non-linear resources to offer to the customers may be determined based on a stability metric computed from the incremental cost and the resource demand, where the combination of resources to offer may have a more linear increase in cost per resource compared to one of the demanded resources. For example, the cost of adding a new virtual machine to an already active server or activating a new server.

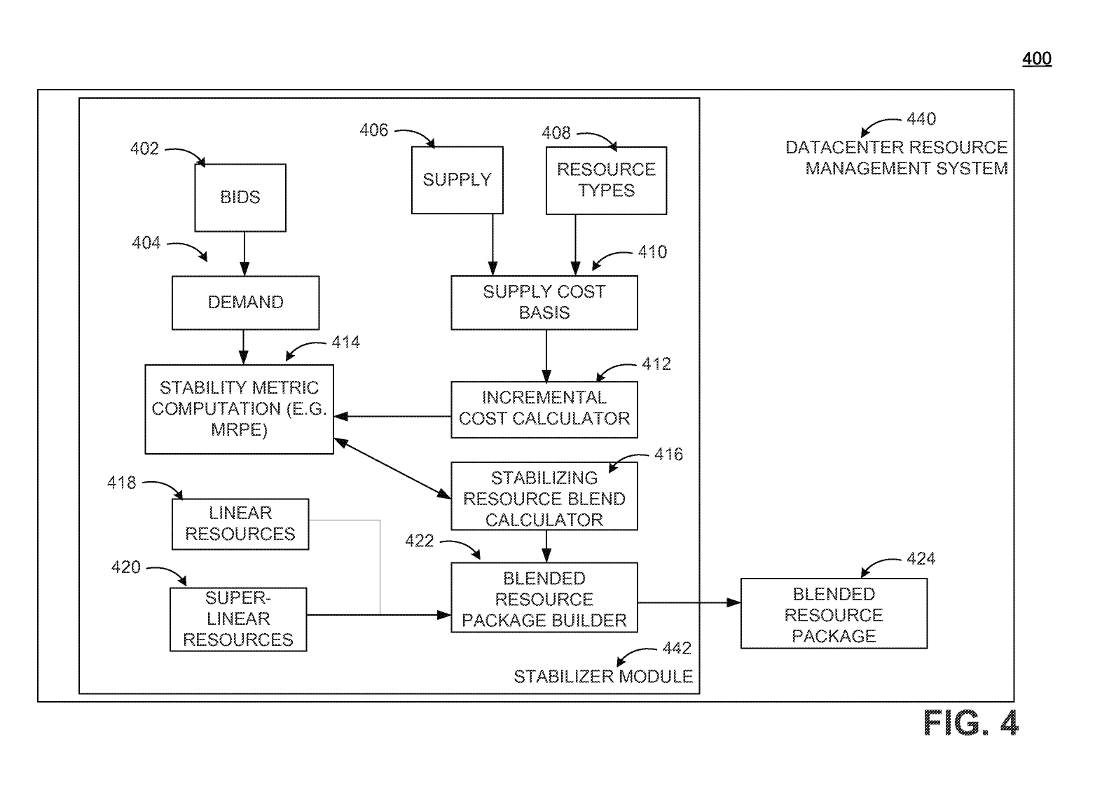

FIG. 4 illustrates a conceptual diagram of a system to induce pricing stability at a datacenter employing a stabilization module, arranged in accordance with at least some embodiments described herein.

As shown in a diagram 400, a datacenter resource management system 440 may be configured to monitor and manage datacenter center pricing. A stabilizer module 442 of the datacenter resource management system 440 may be configured to observe resource demands and current pricing scenarios. The stabilizer module 442 may produce a blended resource package 424 including a combination of the linear and superlinear cost resources to offer to customers such that a more linear increase in cost per resource compared to one of the demanded resources. For example the blended resource package 424 may be subsequently used by an auction or purchase system as the unit of resource purchase to set pricing and details.

In an example embodiment, the stabilizer module 442 may use a history of past bids 402 from customers to compute a demand 404, where the demand 404 may include consideration of winning and non-winning bids received at the datacenter. Supply 406 and resource type information 408 may be used to track a supply cost basis 410 and to determine a linearity of each resource unit sold. An incremental cost calculator 412 may determine an incremental cost basis based on the tracked supply cost basis 410 and determined linearity for each resource unit sold. The incremental cost basis may be determined based on a resource type and a current resource supply cost.

The incremental cost basis and a most recent supply offering may be sent along with the demand 404 to a stability metric computation 414, where stability metric may be determined. In some examples, a maximal relative price elasticity (MRPE) may be calculated as a stability metric. The MRPE is defined as a maximal ratio of generalized price elasticity of customers to the generalized price elasticity of products, and may use the demand 404 and a relative cost slope to detect instability. As the ratio increases, the system may become more volatile, eventually becoming unstable as the MRPE exceeds 1. The MRPE stability metric may be used to compute a stabilizing resource blend at a stabilizing resource blend calculator 416. The stabilizing resource blend calculator 416 may evaluate a mix of linear and superlinear resources that may keep the MRPE less than 1, which may dampen instabilities that are detected to be forming by the stabilizer module 442. The stabilizing resource blend calculator 416 may provide a list of combinations of linear and superlinear resources that keep MRPE less than 1 to a blended resource package builder 422 of the stabilizer module 442.

In an example embodiment, the stability metric computation 414 may be performed statistically (e.g., using a Bayesian estimator) to allow the datacenter to manipulate an acceptable probability of pricing instability. Manipulation of the acceptable probability may allow the datacenter to adjust the acceptability of sudden volatility based on remaining reserve resources available to dampen the volatility and instability. Such adjustments may allow the system to continue to optimize profit and cost while taking advantage of the stabilizing effects of the stabilizer module 442.

In an example embodiment, the blended resource package builder 422 may identify available linear resources 418 having a linear incremental cost but having a higher cost basis (such as activating new server processors), and superlinear resources 420 having a lower cost basis but a superlinear incremental cost (such as adding a VM to other VMs on a processor in a way that requires raising frequency and/or voltage) to provide the blended resource package 424 that minimizes costs while stabilizing customer bidding. The blended resource package 424 may be provided to the datacenter resource management system 440. The blended resource package 424 may increase the absolute cost basis enough to stabilize bidding feedback loop across multiple bidding cycles, and keep costs efficient while preventing dramatic positive feedback loops. In some example scenarios, the blended resource package 424 may be more expensive than a lower price available at the time, however, higher upfront costs may save overall costs in the long term and avoid datacenter instabilities. An actual cost in comparison to a cost of an un-stabilized datacenter may be likely to be lower because the stabilized datacenter may need fewer resources and use them more.

As an example scenario, the blended resource package builder 422 of the stabilizer module 442 may deliver a blended resource package of resources that entails a combination of starting up new servers and adding virtual machines to existing servers. As the package of resources is managed across multiple bid-offer pricing cycles, customers may see a lower slope of price change that in turn impacts the customers' price expectations, preventing a positive feedback induced instability. The blended resource package 424 may decrease the feedback loop gain by changing a derivative of the price function, which in turn may impact the response of the customers. In a system according to embodiments, multiple blended resource packages may be provided to the datacenter resource management system 440 for the datacenter resource management system 440 to auction and provision to customers in real-time.

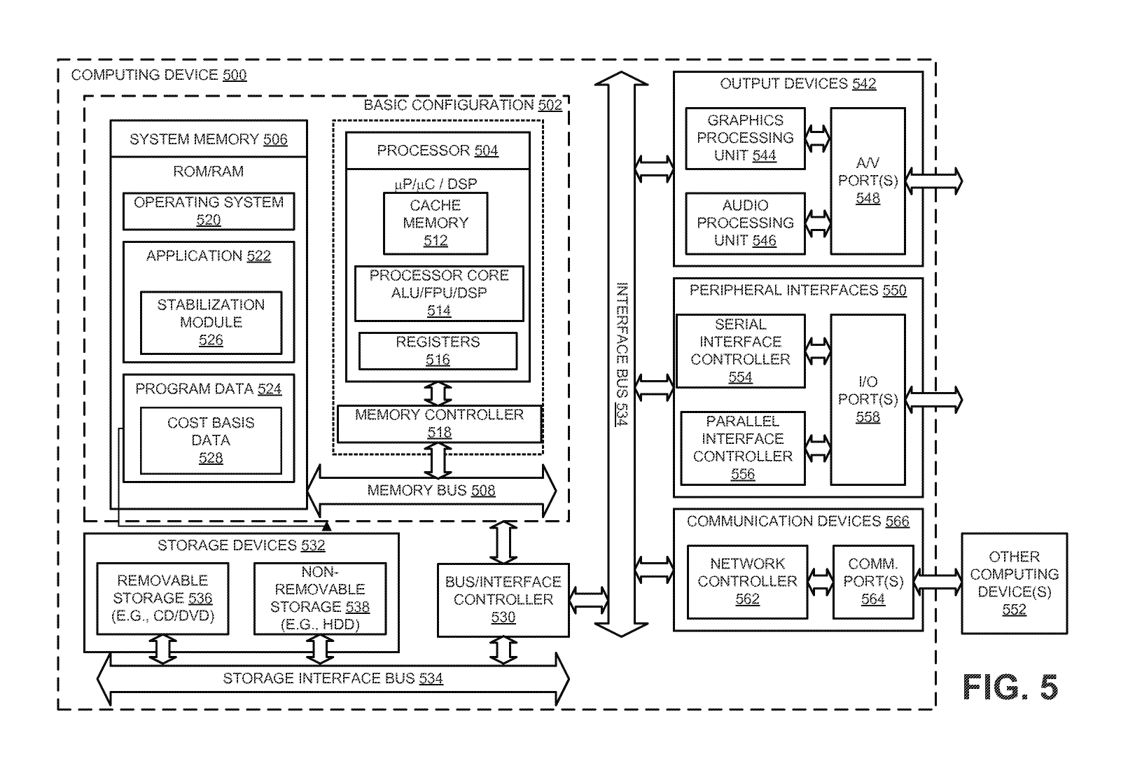

FIG. 5 illustrates a general purpose computing device, which may be used to control a system for providing a stabilizing resource package to prevent datacenter pricing instability, arranged in accordance with at least some embodiments as described herein.

For example, a computing device 500 may be used as a server, desktop computer, portable computer, smart phone, special purpose computer, or similar device. In an example basic configuration 502, the computing device 500 may include one or more processors 504 and a system memory 506. A memory bus 508 may be used for communicating between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one more levels of caching, such as a level cache memory 512, one or more processor cores 514, and registers 516. The example processor cores 514 may (each) include an arithmetic logic unit (ALU), a floating point unit (FPU), a digital signal processing core (DSP Core), or any combination thereof. An example memory controller 518 may also be used with the processor 504, or in some implementations, the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, one or more applications 522, and program data 524. The application 522 may include a stabilization module 526, which may be an integral part of the application 522 or a separate application on its own.

The stabilization module 526 may facilitate identifying an approaching pricing instability and determining a combination of linear and superlinear resources to offer to customers to avoid the approaching pricing instability. The program data 524 may include, among other data, cost basis data 528 determined by the stabilization module 526 based on past user bids, and supply and resource types, for example, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDD), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 550, and one or more communication devices 566) to the basic configuration 502 via the bus/interface controller 530. Some of the example output devices 542 include a graphics processing unit 544 and an audio processing unit 546, which may be configured to communicate to various external devices such as a display or speakers via one or more A/V ports 548. One or more example peripheral interfaces 550 may include a serial interface controller 554 or a parallel interface controller 556, which may be configured to communicate with external devices such as input devices (for example, keyboard, mouse, pen, voice input device, touch input device, etc.) or other peripheral devices (for example, printer, scanner, etc.) via one or more I/O ports 558. An example communication device 566 includes a network controller 562, which may be arranged to facilitate communications with one or more other computing devices 552 over a network communication link via one or more communication ports 564. The one or more other computing devices 552 may include servers, client devices, smart appliances, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a general purpose or specialized server, mainframe, or similar computer that includes any of the above functions. The computing device 500 may also be implemented as a personal computer including both laptop computer and non-laptop computer configurations.

Example embodiments may also include methods to provide a stabilizing resource package to prevent datacenter pricing instability. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

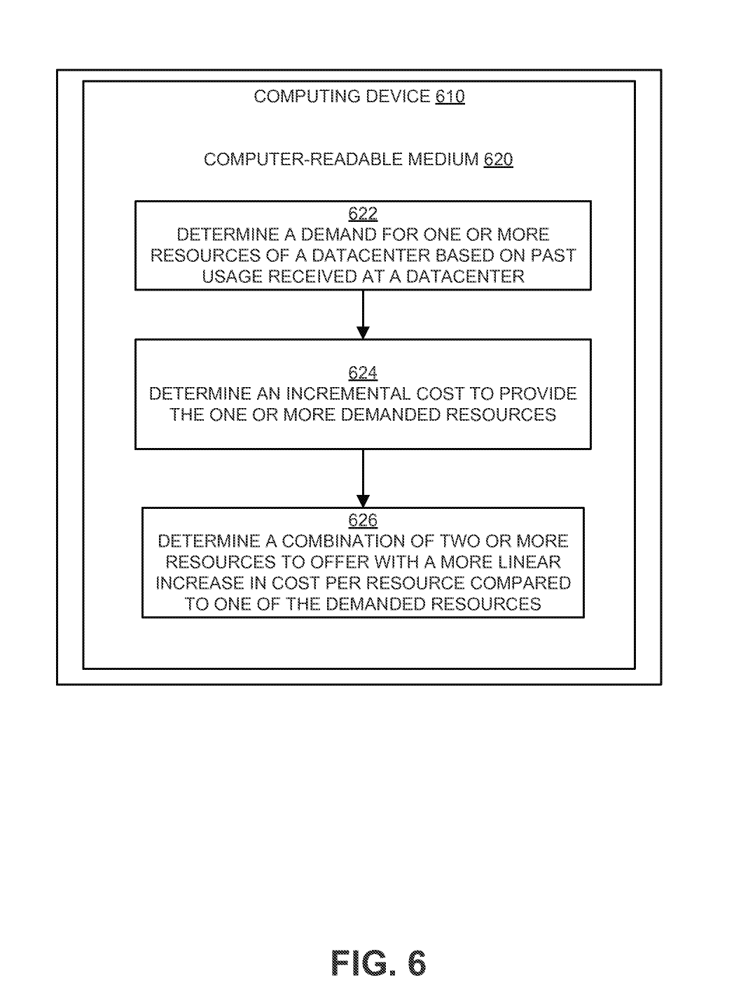

FIG. 6 is a flow diagram illustrating an example method that may be performed by a computing device such as the computing device in FIG. 5, arranged in accordance with at least some embodiments as described herein.

Example methods may include one or more operations, functions or actions as illustrated by one or more of blocks 622, 624, and/or 626. The operations described in the blocks 622 through 626 may also be stored as computer-executable instructions in a computer-readable medium such as a computer-readable medium 620 of a computing device 610.

An example process to provide a stabilizing resource package to prevent datacenter pricing instability may begin with block 622, “DETERMINE A DEMAND FOR ONE OR MORE RESOURCES OF A DATACENTER BASED ON PAST USAGE RECEIVED AT A DATACENTER,” where a stabilizer module (e.g., the stabilizer module 442) may determine a demand for resources based on past winning and non-winning customer bids for resources at the datacenter.

Block 622 may be followed by block 624, “DETERMINE AN INCREMENTAL COST TO PROVIDE THE ONE OR MORE DEMANDED RESOURCES,” where an incremental cost to provide the demanded resources may be computed by the stabilizer module. The incremental cost may be based on a resource type and a current resource supply cost, for example. The stabilizer module may also determine a linearity of the incremental cost or several cost increments of providing the demanded resources, where the linearity may be linear (including sublinear) or superlinear.

Block 624 may be followed by block 626, “DETERMINE A COMBINATION OF TWO OR MORE RESOURCES TO OFFER WITH A MORE LINEAR INCREASE IN COST PER RESOURCE COMPARED TO ONE OF THE DEMANDED RESOURCES,” where the stabilizer module may determine combinations of two or more linear and superlinear cost resources to offer to customers to prevent positive feedback induced pricing instability at the datacenter.

The blocks included in the above described process are for illustration purposes. Provision of a stabilizing resource package to prevent datacenter pricing instability may be implemented by similar processes with fewer or additional blocks. In some embodiments, the blocks may be performed in a different order. In some other embodiments, various blocks may be eliminated. In still other embodiments, various blocks may be divided into additional blocks, or combined together into fewer blocks.

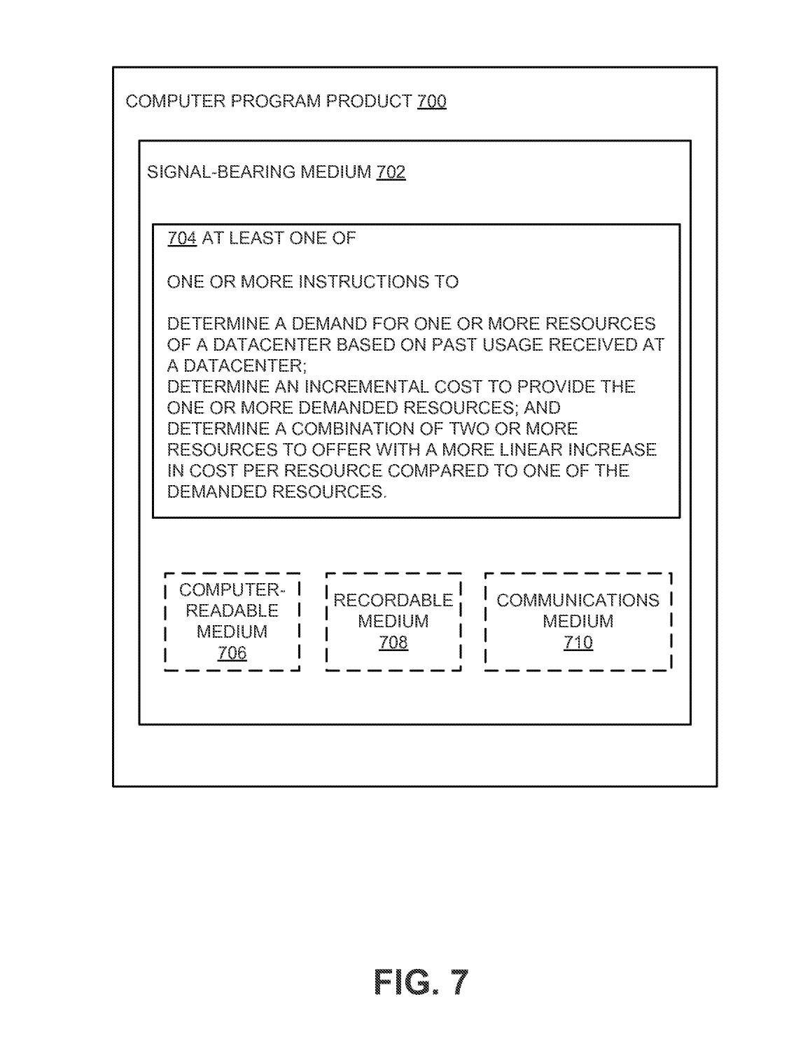

FIG. 7 illustrates a block diagram of an example computer program product, arranged in accordance with at least some embodiments as described herein.

In some embodiments, as shown in FIG. 7, the computer program product 700 may include a signal bearing medium 702 that may also include one or more machine readable instructions 704 that, when executed by, for example, a processor may provide the functionality described above with respect to FIG. 5. Thus, for example, referring to the processor 504 in FIG. 5, the stabilization module 526 executed on the processor 504 may undertake one or more of the tasks shown in FIG. 7 in response to the instructions 704 conveyed to the processor 504 by the medium 702 to perform actions associated with providing a stabilizing resource package to prevent datacenter pricing instability as described herein. Some of those instructions may include, for example, one or more instructions to determine a demand for one or more resources of a datacenter based on past usage received at a datacenter, determine an incremental cost to provide the one or more demanded resources, and determine a combination of two or more resources to offer with a more linear increase in cost per resource compared to one of the demanded resources, according to some embodiments described herein.

In some implementations, the signal bearing medium 702 depicted in FIG. 7 may encompass a computer-readable medium 706, such as, but not limited to, a hard disk drive, a solid state drive, a Compact Disc (CD), a Digital Versatile Disk (DVD), a digital tape, memory, etc. In some implementations, the signal bearing medium 702 may encompass a recordable medium 708, such as, but not limited to, memory, read/write (R/W) CDs, R/W DVDs, etc. In some implementations, the signal bearing medium 702 may encompass a communications medium 710, such as, but not limited to, a digital and/or an analog communication medium (for example, a fiber optic cable, a waveguide, a wired communications link, a wireless communication link, etc.). Thus, for example, the program product 700 may be conveyed to one or more modules of the processor 504 of FIG. 5 by an RF signal bearing medium, where the signal bearing medium 702 may be conveyed by the wireless communications medium 710 (for example, a wireless communications medium conforming with the IEEE 802.11 standard).

According to some examples, the present disclosure describes methods to induce datacenter pricing stability. Example methods may include determining a demand for one or more resources of the datacenter based on past usage received at a datacenter, determining an incremental cost to provide the one or more demanded resources, and determining a combination of two or more resources to offer, where the combination of resources to offer has a more linear increase in cost per resource compared to one of the demanded resources. Determining the demand for the one or more resources of the datacenter based on past usage may include determining the demand based on winning and non-winning bids received at the datacenter.

According to other examples, the pricing structure may be an auction pricing structure or a demand-based pricing structure. Determining the incremental cost may include determining the incremental cost based on a resource type and a current resource supply cost.

According to further examples, the method may include determining a linearity of the incremental cost to provide the one or more demanded resources, where the linearity may be linear or superlinear. The method may also include computing a stability metric that indicates a stability in the pricing structure of the datacenter based on the incremental cost, the determined demand, and/or a most recent resource supply offering.

According to other examples, computing the stability metric may include employing a statistical computation that enables manipulation of a probability of an acceptable pricing instability.

Computing the stability metric may also include determining a maximal relative price-elasticity (MRPE) metric that indicates an instability of the pricing structure datacenter when the MRPE metric may be a value greater than one.

According to further examples, the method may include computing a stabilizing resource blend based on the stability metric. Computing the stabilizing resource blend may include determining a combination of linear resources and superlinear resources that maintain an MRPE metric at a value less than one. The method may also include providing the stabilizing resource blend to a datacenter resource management system, where the stabilizing resource blend includes one or more combinations of one or more resources having a linear incremental cost and one or more resources having a superlinear incremental cost.

According to some embodiments, the present disclosure also describes systems to induce datacenter pricing stability. Example systems may include a datacenter resource management system, and a stabilizer module communicatively coupled to the datacenter resource management system, where the stabilizer module may be configured to determine a demand for one or more resources of the datacenter based on winning and non-winning bids received at the datacenter, compute an incremental cost to provide the one or more resources based on a resource type and a current resource supply cost, and determine a combination of two or more resources to offer based on the incremental cost, where the combination of resources to offer has a more linear increase in cost per resource compared to one of the demanded resources.

According to other embodiments, the stabilizer module may be further configured to determine a linearity of the incremental cost of providing the one or more resources, where the linearity may be linear or superlinear. The stabilizer module may also be configured to compute a stability metric based on the incremental cost, the determined demand, and a most recent resource supply offering, where the stability metric indicates a stability in the pricing structure of the datacenter. The stabilizer module may be further configured to compute the stability metric based on a Bayesian statistical computation, where the Bayesian statistical computation may be selected to enable manipulation of a probability of an acceptable pricing instability.

According to further embodiments, the stabilizer module may be further configured to compute the stability metric based on determination of a maximal relative price-elasticity (MRPE) metric, where the MRPE metric indicates an instability of the pricing structure datacenter when the MRPE metric may be a value greater than one.

According to other examples, the stabilizer module may be further configured to determine a stabilizing resource blend that includes a combination of one or more resources having a linear incremental cost and one or more resources having a superlinear incremental cost based on the stability metric at a blended resource package builder component of the stabilizer module. The blended resource package builder component may be configured to provide one or more blended resource packages based on the computed stabilizing resource blend to the datacenter resource management system.

According to further examples, a resource having a linear incremental cost may include a new virtual machine initiated on a new server. A resource having a superlinear incremental cost may include a new virtual machine added to an existing populated server.

According to some examples, the present disclosure describes computing devices to induce datacenter pricing stability. An example computing device may include a memory configured to store instructions and a processor configured to execute a stabilizer module in conjunction with the instructions. The stabilizer module may be configured to determine a demand for one or more resources of a datacenter based on winning and non-winning bids received at the datacenter, compute an incremental cost to provide the one or more resources based on a resource type and a current resource supply cost, and determine a combination of two or more resources to offer based on a stability metric computed from the incremental cost and the determined demand, where the combination of resources to offer has a more linear increase in cost per resource compared to one of the demanded resources.

According to other examples, the stabilizer module may be further configured to determine a linearity of the incremental cost of providing the one or more resources, where the linearity may be linear or superlinear. The stability metric may indicate a stability in the pricing structure of the datacenter.

According to further examples, the stabilizer module may be further configured to compute the stability metric based on a Bayesian statistical computation, where the Bayesian statistical computation enables manipulation of a probability of an acceptable pricing instability.

According to some embodiments, the stabilizer module may be further configured to compute the stability metric based on determination of a maximal relative price-elasticity (MRPE) metric, where the MRPE metric indicates an instability of the pricing structure datacenter when the MRPE metric may be a value greater than one. The stabilizer module may be also configured to determine a stabilizing resource blend based on the stability metric at a blended resource package builder component of the stabilizer module.

According to other embodiments, the stabilizing resource blend may include a combination of one or more resources having a linear incremental cost and one or more resources having a superlinear incremental cost. The blended resource package builder component may be configured to provide one or more blended resource packages based on the computed stabilizing resource blend to a datacenter resource management system. A resource having a linear incremental cost may include a new virtual machine initiated on a new server, and a resource having a superlinear incremental cost may include a new virtual machine added to an existing populated server.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent techniques and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A typical data processing system may be implemented using any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or, “B” or “A and B.”

While various compositions, techniques, systems, and devices are described in terms of “comprising” various components or steps (interpreted as meaning “including, but not limited to”), the compositions, techniques, systems, and devices can also “consist essentially of” or “consist of” the various components and steps, and such terminology should be interpreted as defining essentially closed-member groups.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to induce datacenter pricing stability, the method comprising:
determining a demand for one or more resources of the datacenter based on one or more of: past usage received at a datacenter, winning bids received at the datacenter, and non-winning bids received at the datacenter;
determining an incremental cost to provide the one or more resources; and
determining a combination of two or more resources to offer, wherein the combination of two or more resources to offer has a more linear increase in cost per resource compared to the one or more resources.

2. (canceled)

3. The method of claim 1, wherein a pricing structure is one of: an auction pricing structure and a demand-based pricing structure.

4. The method of claim 1, wherein determining the incremental cost comprises:
determining the incremental cost based on a resource type and a current resource supply cost.

5. (canceled)

6. The method of claim 1, further comprising:
computing a stability metric that indicates a stability in a pricing structure of the datacenter based on one or more of the incremental cost, the determined demand, and a most recent resource supply offering.

7. The method of claim 6, wherein computing the stability metric comprises:
employing a statistical computation that enables manipulation of a probability of an acceptable pricing instability.

8. The method of claim 6, wherein computing the stability metric comprises:
determining a maximal relative price-elasticity (MRPE) metric that indicates an instability of a pricing structure datacenter when the MRPE metric is a value greater than one.

9. The method of claim 6, further comprising:
computing a stabilizing resource blend based on the stability metric.

10. The method of claim 9, wherein computing the stabilizing resource blend comprises:
determining a combination of linear resources and superlinear resources that maintain an MRPE metric at a value less than one.

11. The method of claim 10, further comprising:
providing the stabilizing resource blend to a datacenter resource management system, wherein the stabilizing resource blend includes one or more combinations of one or more resources having a linear incremental cost and the one or more resources having a superlinear incremental cost.

12. A system to induce datacenter pricing stability, comprising:
a datacenter resource management system; and
a stabilizer module communicatively coupled to the datacenter resource management system, the stabilizer module configured to:
determine a demand for one or more resources of the datacenter based on winning and non-winning bids received at the datacenter;
compute an incremental cost to provide the one or more resources based on a resource type and a current resource supply cost;
determine a linearity of the incremental cost of providing the one or more resources, wherein the linearity is linear or superlinear; and
determine a combination of two or more resources to offer, wherein the combination of resources to offer has a more linear increase in cost per resource compared to the one or more resources.

13. (canceled)

14. The system of claim 12, wherein the stabilizer module is further configured to: determine a linearity of the incremental cost of providing the one or more resources, wherein the linearity is linear or superlinear.

15. The system of claim 14, wherein the stabilizer module is further configured to:
compute a stability metric based on the incremental cost, the determined demand, and a most recent resource supply offering, wherein the stability metric indicates a stability in a pricing structure of the datacenter.

16. The system of claim 15, wherein the stabilizer module is further configured to:
compute the stability metric based on a Bayesian statistical computation, wherein the Bayesian statistical computation is selected to enable manipulation of a probability of an acceptable pricing instability.

17. The system of claim 15, wherein the stabilizer module is further configured to compute the stability metric based on determination of a maximal relative price-elasticity (MRPE) metric, wherein the MRPE metric indicates an instability of the pricing structure datacenter when the MRPE metric is a value greater than one.

18. The system of claim 17, wherein the stabilizer module is further configured to:
determine a stabilizing resource blend that includes a combination of one or more resources having a linear incremental cost and the one or more resources having a superlinear incremental cost based on the stability metric at a blended resource package builder component of the stabilizer module.

19. The system of claim 18, wherein the blended resource package builder component is configured to provide one or more blended resource packages based on the computed stabilizing resource blend to the datacenter resource management system.

20. (canceled)

21. (canceled)

22. A computing device to induce datacenter pricing stability, the computing device comprising:
a memory configured to store instructions; and
a processor configured to execute a stabilizer module in conjunction with the instructions, the stabilizer module configured to:
determine a demand for one or more resources of a datacenter based on winning and non-winning bids received at the datacenter
compute an incremental cost to provide the one or more resources based on a resource type and a current resource supply cost;
determine a linearity of the incremental cost of providing the one or more resources, wherein the linearity is linear or superlinear; and
determine a combination of two or more resources to offer based on a stability metric computed from the incremental cost and the determined demand, wherein the combination of resources to offer has a more linear increase in cost per resource compared to the one or more resources.

23. (canceled)

24. (canceled)

25. The computing device of claim 22, wherein the stabilizer module is further configured to:
compute the stability metric based on a Bayesian statistical computation, wherein the Bayesian statistical computation enables manipulation of a probability of an acceptable pricing instability.

26. The computing device of claim 22, wherein the stabilizer module is further configured to compute the stability metric based on determination of a maximal relative price-elasticity (MRPE) metric, wherein the MRPE metric indicates an instability of a pricing structure datacenter when the MRPE metric is a value greater than one.

27. (canceled)

28. (canceled)

29. (canceled)

30. The computing device of claim 22, wherein the one or more resources that have a linear incremental cost includes a new virtual machine initiated on a new server, and the one or more resources that have a superlinear incremental cost include a new virtual machine added to an existing populated server.
